(19) United States
(12) Patent Application Publication
(10) Pub. No.: US 2010/0260631 A1
(43) Pub. Date: Oct. 14, 2010

(54) MULTI-PIECE CONNECTING ROD

(75) Inventors: Vladimir Kugelev, Arlington, TX (US); Mark D. Matzner, Burleson, TX (US)

Correspondence Address: BRACEWELL & GIULIANI LLP, P.O. BOX 61389, HOUSTON, TX, 77208-1389, US

(73) Assignee: WEIR SPM, INC., Fort Worth, TX (US)

(21) Appl. No.: 12/683,900

(22) Filed: Jan. 7, 2010

Related U.S. Application Data
(60) Provisional application No. 61/143,289, filed on Jan. 8, 2009.

(51) Int. Cl. F04B 53/14; F16C 7/02

(52) U.S. Cl. 417/437; 74/579 R

(57) ABSTRACT

A reciprocating pump assembly having a pump within a housing. The pump having a crankshaft that rotates and a crosshead that is connected to a plunger via a pony rod. The plunger pumps fluid through cylinders in the pump. A connecting rod connects at one end to the crankshaft and at another end to the crosshead to translate the crankshaft's rotational movement into linear movement of the crosshead and thereby the plunger. The connecting rod is fabricated from multiple pieces, with the body of the connecting rod fabricated out of light weight aluminum and the end connected to the crosshead fabricated out of steel. The steel end of the connecting rod can withstand the stress at the crosshead. The lighter weight of the connecting rod lightens the weight of the pump and its transportation is easier and less costly.

### CROSS-REFERENCE TO RELATED APPLICATION

This application claims priority to provisional application 61/143,289 filed Jan. 8, 2009.

### FIELD OF THE INVENTION

This invention relates in general to connecting rods used in reciprocating pump crankshafts, and, in particular, to a multi-piece connecting rod fabricated out of steel and a lighter weight material to lighten its weight.

### BACKGROUND OF THE INVENTION

Connecting rods are used in various kinds of pumps used in oilfield operations. A connecting rod can be used, for example, in a reciprocating pump. The reciprocating pump can be used to pump fluid such as chemicals, cement, or other media into a well. Reciprocating pumps typically increase the pressure within a cylinder by reciprocating a plunger longitudinally within the cylinder. The connecting rod typically has a body and two ends. One end bolts to the crank shaft and the other end pivotally secures to a crosshead. The crosshead strokes longitudinally within a crosshead housing and is connected to a pony rod, which in turn in connected to the plunger.

In a one prior example, one end of a connecting rod is connected to the plunger via a crosshead and the other end is connected to a crankshaft. The crosshead has a semi-cylindrical cavity that receives one end of the connecting rod. To secure the end of the connecting rod to the crosshead, a wrist pin is inserted through a hole formed in the crosshead end of the connecting rod. The wrist pin thus secures the end of the connecting rod to the crosshead and allows for the translation of the crankshaft's rotational movement into linear movement of the crosshead and thereby the plunger. Connecting rods are typically fabricated out of a single piece of steel. The steel construction provides the connecting rod with the strength to bear the forces experienced during operation, especially at the crosshead. As such, the connecting rod is heavy and adds to the overall pump weight, which can make the transportation of reciprocating pumps more difficult. For example, these pumps are often mounted on trailers that are brought to the wellsite. The trailers cannot exceed the weight capacity of any bridges that it must cross or weight limits on highways.

Thus, it would be desirable to provide a connecting rod for use in reciprocating pumps that is lighter and yet maintains the ability to bear the forces experienced during pump operation.

### SUMMARY OF THE INVENTION

In an embodiment of the present invention, a reciprocating pump assembly has a pump located inside a housing. The pump has a crankshaft that rotates and a crosshead that is connected to a plunger via a pony rod. The plunger pumps fluid through cylinders in the pump when it is moved longitudinally within the cylinders. A connecting rod has a body and connects at one endpiece to the crankshaft and at another endpiece to the crosshead to thereby translate the crankshaft's rotational movement into linear movement of the crosshead and thereby energize the plunger.

In this embodiment, the endpiece that is connected to the crosshead is made of steel has an interference fit with the body of the connecting rod, which is made of a lighter material, preferably aluminum. In addition, fasteners may be used for added security. Alternatively, the fasteners may be omitted. This endpiece can be secured to the crosshead by a wrist pin that traverses a hole formed in the endpiece. The wrist pin allows the connecting rod's endpiece to pivot during pump operation. The crankshaft end piece may be of aluminum and integral with the body. This multi-piece design using a lighter aluminum metal results in a lighter connecting rod and thus reduces the weight of the pump. This can result in making transportation of the pump easier and less costly.

### BRIEF DESCRIPTION OF THE DRAWINGS

FIG. 1 is an illustration of a reciprocating pump constructed in accordance with the invention;

FIG. 2 is an illustration of the multi-piece connecting rod's location within the reciprocating pump crankshaft housing of the pump of FIG. 1, and is constructed in accordance with the invention;

FIG. 3 an enlarged side view of the multi-piece connecting rod of FIG. 2;

FIG. 4 is cross sectional view of the connecting rod of FIG. 3, taken along the line 4-4;

FIG. 5 is a cross sectional view of the connecting rod of FIG. 3, taking along the line 5-5;

FIG. 6 is an enlarged sectional view of an alternative embodiment of the multi-piece connecting rod, and is constructed in accordance with the invention;

FIG. 7 is an illustration of an alternative embodiment of the cross section shown in FIG. 5.

### DETAILED DESCRIPTION OF THE INVENTION

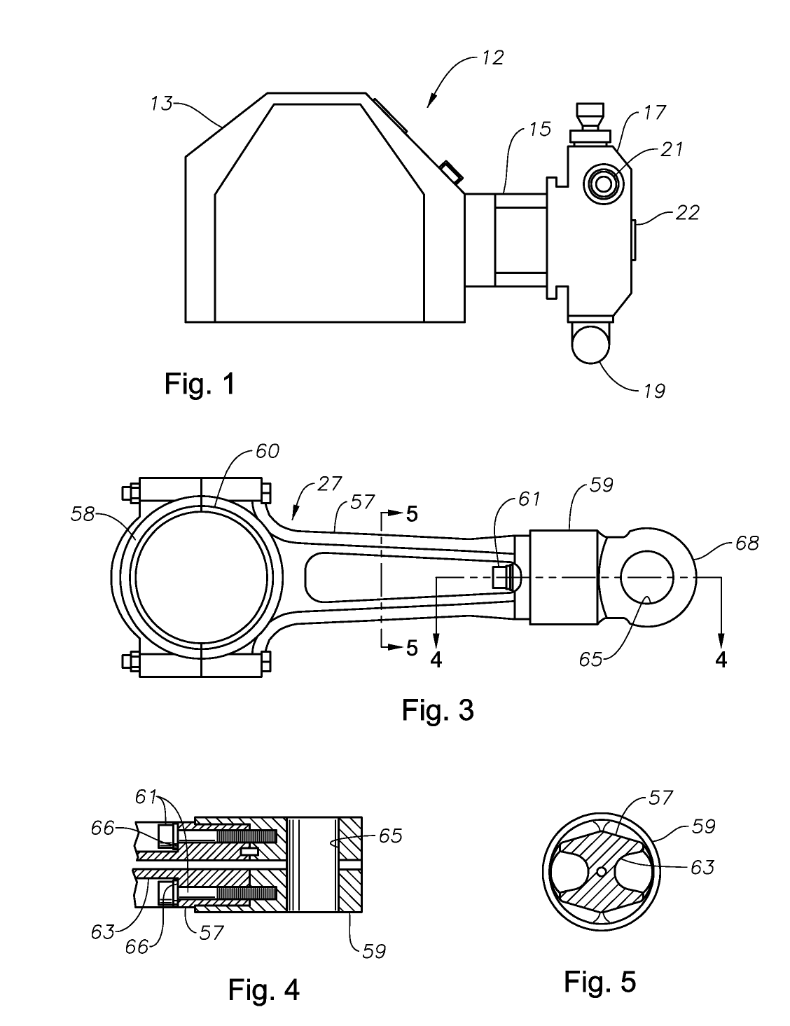

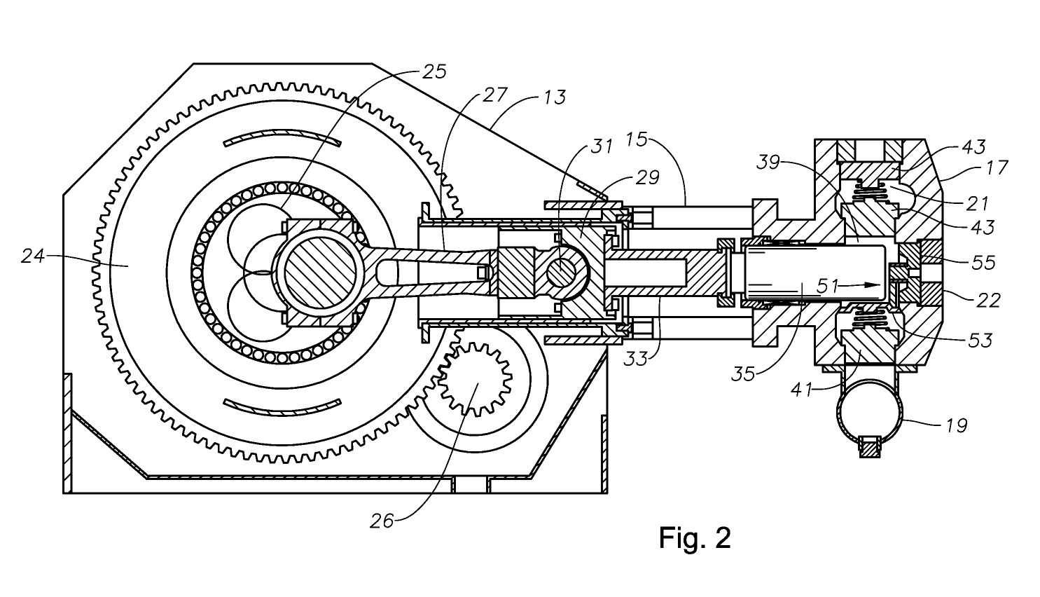

Referring to FIGS. 1 and 2, reciprocating pump assembly or pump 12 includes a crankshaft housing 13 that comprises a majority of the outer surface of reciprocating pump 12. Stay rods 15 attach to a side of crankshaft housing 13 and extend to a set of cylinders 17. Each cylinder 17 communicates with a fluid inlet 19 and a fluid outlet 21. As shown in FIGS. 1 and 2, a suction cover plate 22 connects to an end of each cylinder 17 opposite the crankshaft housing 13. Pump 12 is can be free-standing on the ground, can be mounted to a trailer that can be towed between operational sites, or mounted to a skid such as for offshore operations.

Referring to FIG. 2, a portion of reciprocating pump 12 housed within crankshaft housing 13 is shown. Crankshaft housing 13 houses a crankshaft 25, which is typically mechanically connected to a motor (not shown). The motor rotates crankshaft 25 in order to drive reciprocating pump 12 (FIG. 1). In one embodiment, crankshaft 25 is cammed so that fluid is pumped from each cylinder 17 at alternating times. As is readily appreciable by those skilled in the art, alternating the cycles of pumping fluid from each of cylinders 17 helps minimize the primary, secondary, and tertiary (et al.) forces associated with reciprocating pump 12 (FIG. 1).

In one embodiment, a gear 24 is mechanically connected to crankshaft 25 and is rotated by the motor through gears 26 and 24. A multi-piece connecting rod 27 is connected to the crankshaft 25 at one end. The connecting rod 27 connects to a crosshead 29 through a crosshead wrist pin 31, which holds connecting rod 27 longitudinally relative to crosshead 29. The crosshead 29 has a concave semi-cylindrical portion to receive the end of the connecting rod. Crosshead 20 reciprocates within a stationary crosshead housing. The multi-piece connecting rod 27 pivots about wrist pin 31 as crankshaft 25 rotates with the other end of connecting rod 27. A pony rod 33 extends from crosshead 29 in a longitudinally opposite direction from crankshaft 25. Connecting rod 27 and crosshead 29 convert rotational movement of crankshaft 25 into longitudinal movement of pony rod 33.

A plunger 35 is connected to pony rod 33 for pumping the fluid passing through cylinder 17. Cylinder 17 includes an interior or cylinder chamber 39, which is where plunger 35 pressurizes the fluid being pumped by reciprocating pump 12 (FIG. 1). Cylinder 17 also typically includes an inlet valve 41 and an outlet valve 43. Valves 41 and 43 are usually spring-loaded valves and are actuated by a predetermined differential pressure. Inlet valve 41 actuates to control fluid flow through fluid inlet 19 into cylinder chamber 39, and outlet valve 43 actuates to control fluid flow through fluid outlet 21 from cylinder chamber 39.

Plunger 35 reciprocates and moves longitudinally within cylinder 17, as crankshaft 25 rotates. As plunger 35 moves longitudinally away from cylinder chamber 39, the pressure of the fluid inside chamber 39 decreases, creating a differential pressure across inlet valve 41, which actuates valve 41 and allows the fluid to enter cylinder chamber 39 from fluid inlet 19. The fluid being pumped enters cylinder chamber 39 as plunger 35 continues to move longitudinally away from cylinder 17 until the pressure difference between the fluid inside chamber 39 and the fluid in fluid inlet 19 is small enough for inlet valve 41 to actuate to its closed position. As plunger 35 begins to move longitudinally towards cylinder 17, the pressure on the fluid inside of cylinder chamber 39 begins to increase. Fluid pressure inside cylinder chamber 39 continues to increase as plunger 35 approaches cylinder 17 until the differential pressure across outlet valve 43 is large enough to actuate valve 43 and allow the fluid to exit cylinder 17 through fluid outlet 21. In one embodiment, fluid is only pumped across one side of plunger 35, therefore reciprocating pump 12 is a single-acting reciprocating pump.

Referring to FIG. 3, an embodiment of the connecting rod 27 is shown. The multi-piece connecting rod 27 comprises a body 57 made of a lighter material than steel, such as aluminum, that attaches to the crankshaft 25 (FIG. 2) on one end. An outermost semicircular retainer 58 is placed over the crankshaft 25 and fastened by bolts to the innermost semicircular portion of a crankshaft endpiece 60. Crankshaft endpiece 60 may be integral with body 57 and thus may be of aluminum. Alternatively, crankshaft endpiece 60 may be fastened to the body 57. Retainer 58 may also be of aluminum. The body 57 optionally may have a hollow interior that extends approximately the length of the body 57. Alternatively, material may be removed from both sides along the body 57 to leave a thin web of material within the body 57.

The crosshead end of the multi-piece connecting rod 27 comprises a steel endpiece 59 that is attached to the aluminum body 57 preferably via an interference fit. For added security, in this embodiment two fasteners 61 may also be used to connect endpiece 59 to body 57, as shown in FIG. 4. In this embodiment, the fasteners 61 pass through passages formed in the body 57 and into corresponding holes formed in the steel endpiece 59. The corresponding holes may be threaded to receive a threaded fastener 61. In this example, the body 57 has a thin web 63 as shown in FIG. 5, where material may be removed from both sides along the body 57 to leave a thin wall of material within the body 57. However, the body 57 can have any suitable cross-section that can withstand the stresses experienced during pump operation, such as round, tube, square, rhomboid, or elliptical cross-sections. Since web 63 is thinner than crosshead endpiece 59, two shoulders 66 are formed on body 57 on opposite sides of web 63. One bolt 61 is on each side of web 63, and the heads of bolts 61 abut shoulders 66.

In this embodiment, a cylindrical wrist pin hole 65 extends through crosshead end 59 perpendicular to an axis of connecting rod body 57. Wrist pin hole 65 connects the endpiece 57 of the connecting rod 27 to the crosshead 29 via the crosshead wrist pin 31. The forward end 68 of crosshead endpiece 59 is convex and partially cylindrical. The crosshead 29 (FIG. 2) has a concave semi-cylindrical portion that receives the cylindrical forward end 68 of steel endpiece 59. The multi-piece connecting rod 27 is unlike connecting rods in the prior art that are made of a single piece.

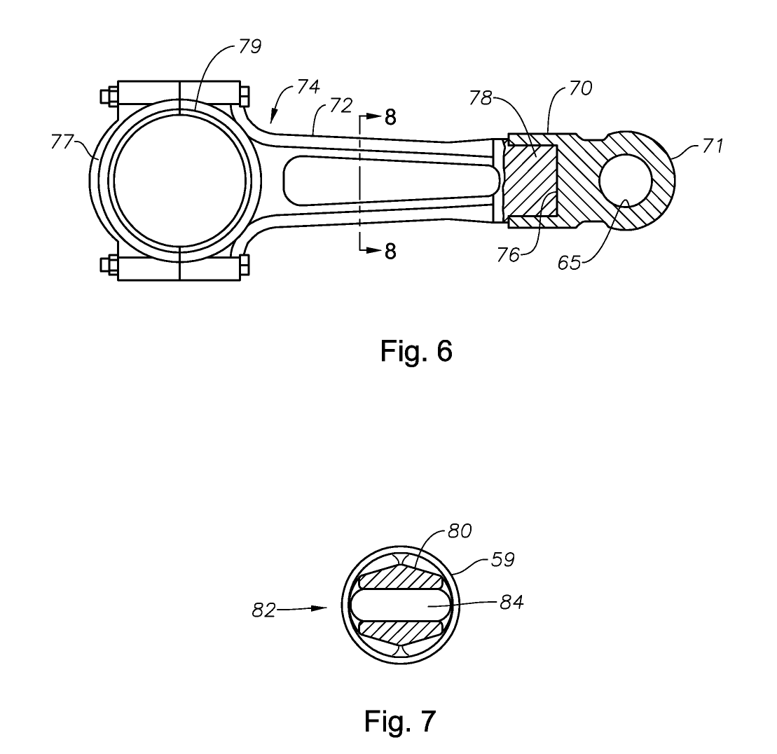

In an additional embodiment illustrated in FIG. 6, the connection between endpiece 70 and the body 72 of connecting rod 74 is via an interference fit. Thus, no fasteners are utilized in this embodiment. The crosshead endpiece 70 has a forward end 71 that is convex and partially cylindrical for reception by crosshead 29 (FIG. 2). The crosshead endpiece further has a cylindrical receptacle 76 located on the axis of connecting rod body 72. Connecting rod body 72 has a cylindrical pin 78 that is on the axis of body 72 and inserts into receptacle 76. The outer diameter of pin 78 is greater than the inner diameter of receptacle 76, creating an interference fit between the endpiece 70 and the body 72 of the connecting rod 74. Similarly to the embodiment of FIG. 3, an outermost semicircular retainer 77 is placed over the crankshaft 25 (FIG. 2) and fastened by bolts to the innermost semicircular portion of a crankshaft endpiece 79.

In an additional embodiment the aluminum body 80 of the multi-piece connecting rod 82 has a hollow interior 84 that extends approximately the length of the body 80, resulting in a cross-section such as that shown in FIG. 7.

Reciprocating pumps 12 are large, and heavy pieces of equipment because the pressures required can be high, up to 20,000 psi. The fluid volumes pumped are also high. Often, pumps of this type are transported to various sites on trailers. Road and bridge weight limits must be met by the trailer. Lightening the weight of the pump by using lighter weight materials for the connecting rod 27 is thus desirable because it makes pump 12 transportation easier and less costly. However, a lighter weight material such as aluminum may not have the ability to withstand the wear and forces at the connection to the crosshead 29. By using a multi-piece connecting rod 27, the pump's weight is lightened because the body 57 of the connecting rod 27 is fabricated out of a light weight material such as aluminum. The lightweight body 57 can then be fastened to the endpiece 59, which is fabricated out of steel and has the strength required to withstand the stress and wear at the crosshead 29.

This written description uses examples to disclose the invention, including the best mode, and also enable a person of ordinary skill in the art to practice the invention, including making and using any devices or systems and performing any incorporated methods. These embodiments are not intended to limit the scope of the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A reciprocating pump assembly, comprising:
a pump housing that houses a crankshaft;
a plunger for pumping a fluid through a cylinder, the cylinder having fluid ports for ingress and egress of fluid;
a crosshead connected to the plunger and movable longitudinally within a crosshead housing; and
a connecting rod having a body, a crankshaft endpiece and a crosshead endpiece, the crankshaft endpiece rotatably connected to the crankshaft, the crosshead endpiece pivotally secured to the crosshead; wherein:
the body is fabricated from a material lighter than steel; and
the crosshead endpiece is fabricated from steel and secured to the body.

2. The reciprocating pump assembly of claim 1, wherein the crosshead endpiece of the connecting rod is secured to the crosshead with a wrist pin that traverses a hole in the crosshead endpiece corresponding to the wrist pin.

3. The reciprocating pump assembly of claim 1, wherein the crosshead has a partially cylindrical concave surface, and the crosshead endpiece has a partially cylindrical exterior surface that slidably fits within the concave surface.

4. The reciprocating pump assembly of claim 1, wherein the body of the connecting rod is formed of aluminum.

5. The reciprocating pump assembly of claim 1, wherein the crosshead endpiece is secured to the body by bolts.

6. The reciprocating pump assembly of claim 1, wherein the crankshaft endpiece is fabricated from the same material as the body and is integrally formed with the body.

7. The reciprocating pump assembly of claim 1, wherein the crankshaft endpiece of the connecting rod has a semicircular recess integral to the body at an end opposite the crosshead endpiece, and a retainer having a semicircular recess inserts around the crankshaft and bolts to the crankshaft endpiece.

8. The reciprocating pump assembly of claim 1, wherein the body of the connecting rod and the crosshead endpiece have a mating pin and socket that are secured to each other with an interference fit.

9. The reciprocating pump assembly of claim 1, wherein the body has a web that joins a larger width end portion, defining a pair of shoulders, and wherein bolts extend through the shoulders into threaded holes in the crosshead endpiece to connect the crosshead endpiece to the body.

10. A reciprocating pump assembly, comprising:
a pump housing that houses a crankshaft;
a plunger for pumping a fluid through a cylinder, the cylinder having fluid ports for ingress and egress of fluid;
a crosshead connected to the plunger and movable longitudinally within a crosshead housing; and
a connecting rod having a body, a crankshaft endpiece and a crosshead endpiece, the crankshaft endpiece rotatably connected to the crankshaft, the crosshead endpiece pivotally secured to the crosshead; wherein:
the body is fabricated from aluminum;
the crosshead endpiece is fabricated from steel and secured to the body;
the crosshead has a partially cylindrical concave surface, and the crosshead endpiece has a partially cylindrical exterior surface that slidably fits within the concave surface; and
the body of the connecting rod and the crosshead endpiece have a mating pin and socket that are secured to each other with an interference fit.

11. The reciprocating pump assembly of claim 10, wherein the crosshead endpiece of the connecting rod is secured to the crosshead with a wrist pin that traverses a hole in the crosshead endpiece corresponding to the wrist pin.

12. The reciprocating pump assembly of claim 10, wherein the body of the connecting rod is formed of aluminum.

13. The reciprocating pump assembly of claim 10, wherein the crosshead endpiece is secured to the body by bolts.

14. The reciprocating pump assembly of claim 10, wherein the crankshaft endpiece is fabricated from aluminum and is integrally formed with the body.

15. The reciprocating pump assembly of claim 10, wherein the crankshaft endpiece of the connecting rod has a semicircular recess integral to the body at an end opposite the crosshead endpiece, and a retainer having a semicircular recess inserts around the crankshaft and bolts to the crankshaft endpiece.

16. The reciprocating pump assembly of claim 10, wherein the body has a web that joins a larger width end portion, defining a pair of shoulders, and wherein bolts extend through the shoulders into threaded holes in the crosshead endpiece to connect the crosshead endpiece to the body.

17. A connecting rod assembly, comprising:
a body fabricated from aluminum;
a crankshaft endpiece adapted to be rotatably connected to a crankshaft, wherein the crankshaft endpiece is fabricated from aluminum and integrally formed with the body; and
a crosshead endpiece adapted to be pivotally secured to a crosshead, wherein the crosshead endpiece is fabricated from steel and secured to the body.

18. The reciprocating pump assembly of claim 17, wherein the crankshaft endpiece of the connecting rod has a semicircular recess integral to the body at an end opposite the crosshead endpiece, and a retainer having a semicircular recess inserts around the crankshaft and bolts to the crankshaft endpiece.

19. The reciprocating pump assembly of claim 17, wherein the body of the connecting rod and the crosshead endpiece have a mating pin and socket that are secured to each other with an interference fit.

20. The reciprocating pump assembly of claim 17, wherein the body has a web that joins a larger width end portion, defining a pair of shoulders, and wherein bolts extend through the shoulders into threaded holes in the crosshead endpiece to connect the crosshead endpiece to the body.
